(19) United States
(12) Patent Application Publication
(10) Pub. No.: US 2017/0033521 A1
(43) Pub. Date: Feb. 2, 2017

(54) Power Assembly

(71) Applicant: Elmer A. Wessel, Lincoln, NE (US)

(72) Inventor: Elmer A. Wessel, Lincoln, NE (US)

(21) Appl. No.: 14/550,633

(22) Filed: Nov. 21, 2014

Related U.S. Application Data
(60) Provisional application No. 61/907,245, filed on Nov. 21, 2013.

(51) Int. Cl. H01R 25/14; H01R 13/66

(52) U.S. Cl. CPC H01R 25/142; H01R 25/145; H01R 13/6683; H01R 13/6666

(57) ABSTRACT

What is disclosed is an apparatus for powering in-store displays. The apparatus is particularly effective in providing power for shelf lighting in the middle of the store. The present invention is an apparatus for lighting aisle displays in a grocery store. It features a central power strip with modular Power-In-Connectors and Power-Out-Connectors. The addition of motion sensors and timers creates interactive and attention drawing displays.

### CROSS-REFERENCES TO RELATED APPLICATIONS

This Application claims priority as a non-provisional perfection of prior filed U.S. Application Ser. No. 61/907,245, filed Nov. 21, 2013, and incorporates the same by reference herein in its entirety.

### FIELD OF THE INVENTION

The present invention relates to the field of merchandisers and more particularly relates to a system to provide power to said merchandizers and even more particularly to provide easily customizable lighting and other attention grabbing systems for merchandizers.

### BACKGROUND OF THE INVENTION

A consumer economy is driven by the purchases of consumers. To that end, many studies, strategies and methods have been performed and developed in order to encourage consumer spending on various products. It is also commonly known that customer service is a large factor in generating the good will of consumers and good will generates purchases. Therefore, providing an intuitive and expected shopping experience encourages both good will and sales.

One aspect of the common consumer experience is the check-out aisle. The check-out aisle is essentially a queue, or a number of queues, in which a consumer waits for a cashier to enter and tally the customer's purchases for payment. The usual construction is a plurality of parallel islands, each one headed with a cashier's station. The cashier stands at the cashier's station and faces and interacts with one side of the island, which forms the near side of the aisle. The neighboring island, which the cashier is facing and from which a cashier in that neighboring station is facing away, forms the far side of the aisle. Check-out aisles are commonly disparaged in the culture and any improvement to the experience is generally noticed. Due to the length of time a customer may spend in a check-out aisle, check-out aisles are frequently stocked with impulse buy items, such as candy, and/or other items that may grab a customer's attention and need more time to generate a desire to buy the item, such as magazines.

It is also well known in the art that appropriate lighting may enhance the display of product. It is for this reason that showrooms were developed to showcase items like automobiles, large appliances, and larger furniture. However, lighting systems in the art of grocery merchandizing is far behind other arts—being limited to utilitarian lighting to make sure people can see product. Interactive lighting displays are not generally utilized in grocery aisles. It is also known that other types of displays maybe more effective when they are animated or utilized and interactive interface.

The present invention is an apparatus by which lighting and other systems may be easily and effectively installed in check-out aisles and general merchandise aisles. The present invention represents a departure from the prior art in that the apparatus is easily adapted to current systems and supplies needed power outlets for lighting the numerous shelves present in check-out and general merchandise aisles. Additionally, the apparatus may be adapted to be keyed to the physical presence of a cashier or customer so that an aisle may be automatically lit with a number of simple lighting paradigms without intentional human intervention. The apparatus may also power other types of displays.

### SUMMARY OF THE INVENTION

In view of the foregoing disadvantages inherent in the known types of aisle lighting apparatuses, this invention provides a simple and efficient apparatus to utilize more effective lighting schemes with aisle lighting. This may include the utilization of motion sensors to provide a more interactive display. As such, the present invention's primary purpose is to provide a new and improved aisle lighting apparatus.

To accomplish these objectives, the best mode apparatus comprises a central power strip with at least two contact strips contained within. Modular Power-In-Connectors (“PICs”) and Power-Out-Connectors (“POCs”) are then connected to the strip, making contact with the contact strips. Lighting modules are then plugged into the POCs and the PIC is connected to a supply. Motion sensors may be utilized as switches. Delay timers may also be utilized to block power from the POCs until a given time has elapsed in order to affect different lighting schemes. These delay timers may be programmable with different delay times for cascading effects. A timer may also serve as a power-off switch in conjunction with a motion sensor for determining a lack of customer presence. The apparatus may also be adapted for individual stock aisles which are formed in a manner similar to the check-out aisles with rows of parallel merchandizers, or “gondolas.” With each aisle being formed from the opposite halves of two adjacent islands or gondolas, it should be readily appreciated, then, that the two halves of each aisle island or gondola are two separate circuits, each one requiring its own central power strip. It should, of course, be readily appreciated that the present invention, while describing its use as being with a lighting system, may be utilized with any suitable electrical power consuming load so long as safety is not compromised, or is suitably enhanced for the load. Accordingly, the use of the term “light,” “LED,” or similar terminology should be read to include other, non-luminous, power loads.

The more important features of the invention have thus been outlined in order that the more detailed description that follows may be better understood and in order that the present contribution to the art may better be appreciated. Additional features of the invention will be described hereinafter and will form the subject matter of the claims that follow.

Many objects of this invention will appear from the following description and appended claims, reference being made to the accompanying drawings forming a part of this specification wherein like reference characters designate corresponding parts in the several views.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### DESCRIPTION OF THE DRAWINGS

FIG. 1 is a top plan view of the lighting power assembly for use in powering merchandizing lighting.

FIG. 2 is a side elevation of the lighting power assembly of FIG. 1. FIG. 3 is a front elevation of the lighting power assembly of FIG. 1.

FIG. 4 is an exploded perspective view of the lighting power assembly of FIG. 1.

FIG. 5 is a top plan view of a PIC used with the lighting power assembly of FIG. 1.

FIG. 6 is a side elevation of the PIC of FIG. 5

FIG. 7 is a front elevation of the PIC of FIG. 5.

FIG. 8 is an exploded view of the PIC of FIG. 5.

FIG. 9 is a top plan view of the circuit board of the PIC of FIG. 5.

FIG. 10 is a side elevation of the circuit board of FIG. 9.

FIG. 11 is a front elevation of the circuit board of FIG. 9.

FIG. 12 is an exploded view of the circuit board of FIG. 9.

FIG. 13 is a bottom plan view of the circuit board of FIG. 9.

FIG. 14 is a rear elevation of the PIC of FIG. 5 and the power strip of FIG. 4, separate.

FIG. 15 is a rear elevation of the PIC of FIG. 5 and the power strip of FIG. 4, attached.

FIG. 16 is a top plan view of a PIC used with the lighting power assembly of FIG. 1.

FIG. 17 is a side elevation of the PIC of FIG. 16

FIG. 18 is a front elevation of the PIC of FIG. 16.

FIG. 19 is an exploded view of the PIC of FIG. 16.

FIG. 20 is a top plan view of the circuit board of the PIC of FIG. 16.

FIG. 21 is a side elevation of the circuit board of FIG. 20.

FIG. 22 is a front elevation of the circuit board of FIG. 20.

FIG. 23 is an exploded view of the circuit board of FIG. 20.

FIG. 24 is a bottom plan view of the circuit board of FIG. 20.

FIG. 25 is a schematic detailing the use of timers and motion sensors with the present invention.

FIG. 26 is a schematic showing the possible design of a timer for use with the present invention.

### DETAILED DESCRIPTION OF THE PREFERRED EMBODIMENT

With reference now to the drawings, the preferred embodiment of the lighting power assembly is herein described. It should be noted that the articles “a”, “an”, and “the”, as used in this specification, include plural referents unless the content clearly dictates otherwise.

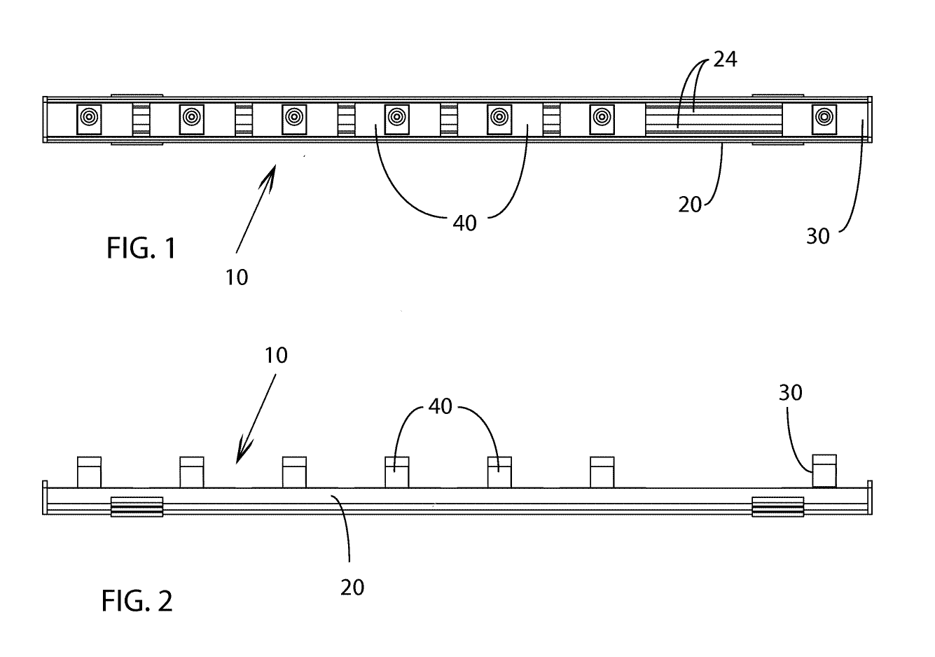

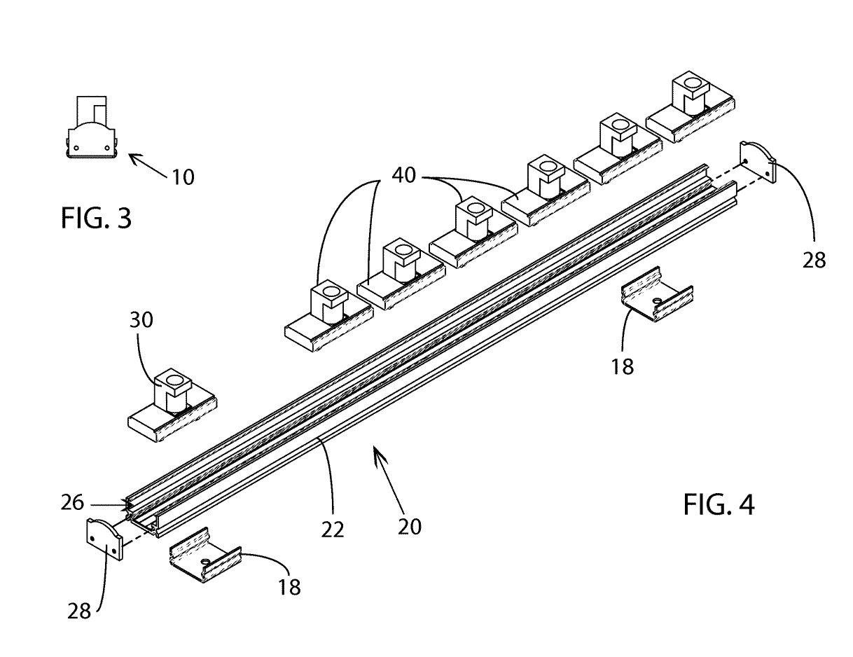

With reference to FIGS. 1-3, the basic assembly 10 is a power strip 20 with at least one Power-In-Connector (“PIC”) 30 and a plurality of Power-Out-Connectors (“POCs”) 40. The power strip 20 features a strip body 22 with at least two parallel conductive contact leads 24 running at least most of the length of the strip body 22. Strip body 22 defines an interior trench 26 in which the conductive contact leads 24 reside. Ideally, the PIC 30 and POCs 40 are manufactured to slide along the inner trench 26 and be secured therein by removable end caps 28. When installed, anchors 18 may be utilized to connect the strip body 22 to a fixture or other structure. Other methods of attaching the PICs 30 and POCs 40 into the strip 20, including a snap lock, are possible, so long as the PICs 30 and POCs 40 make contact with contact leads 24, and still the resultant apparatus would fall in the purview of the invention. It should also be noted that the drawings depict the contact leads 24 along the “bottom” of the inner trench 26. This arrangement may be altered, with one or more contact leads 24 along the sides of the inner trench 26 to lessen exposure to the contact leads 24.

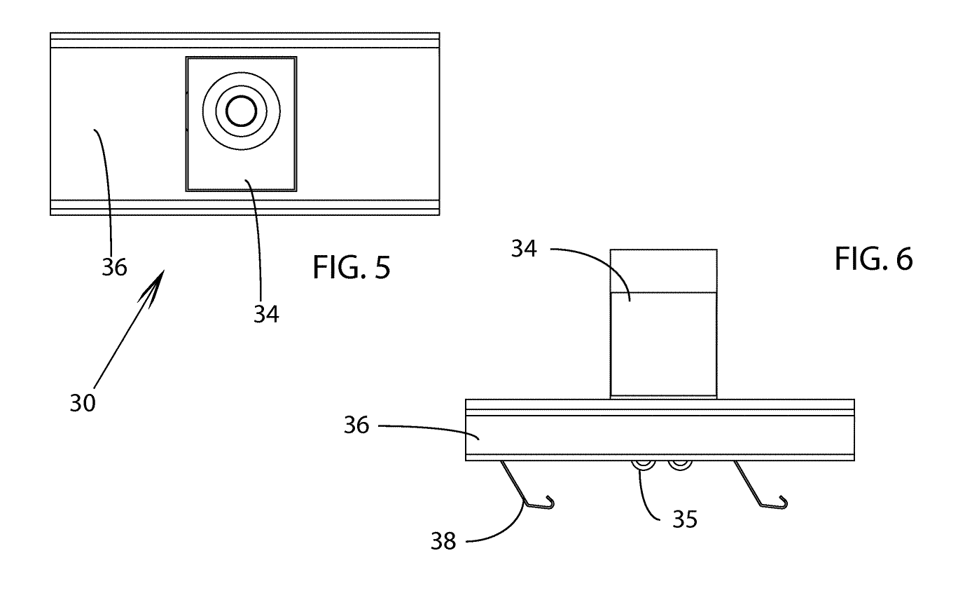

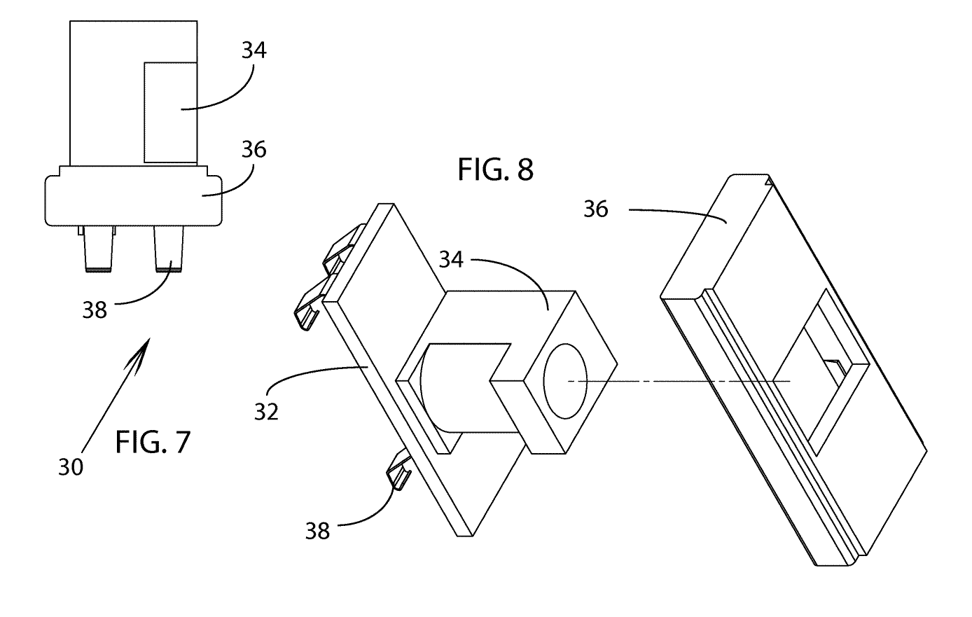

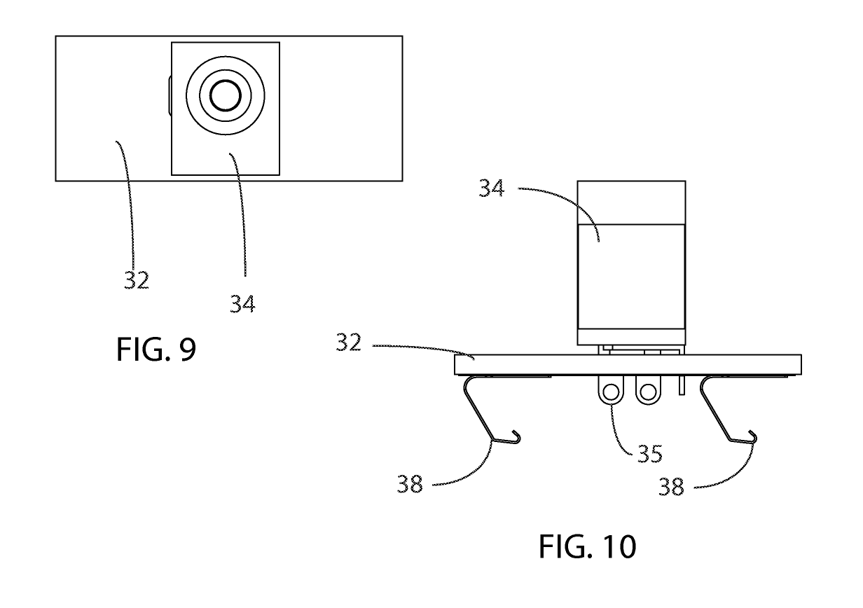

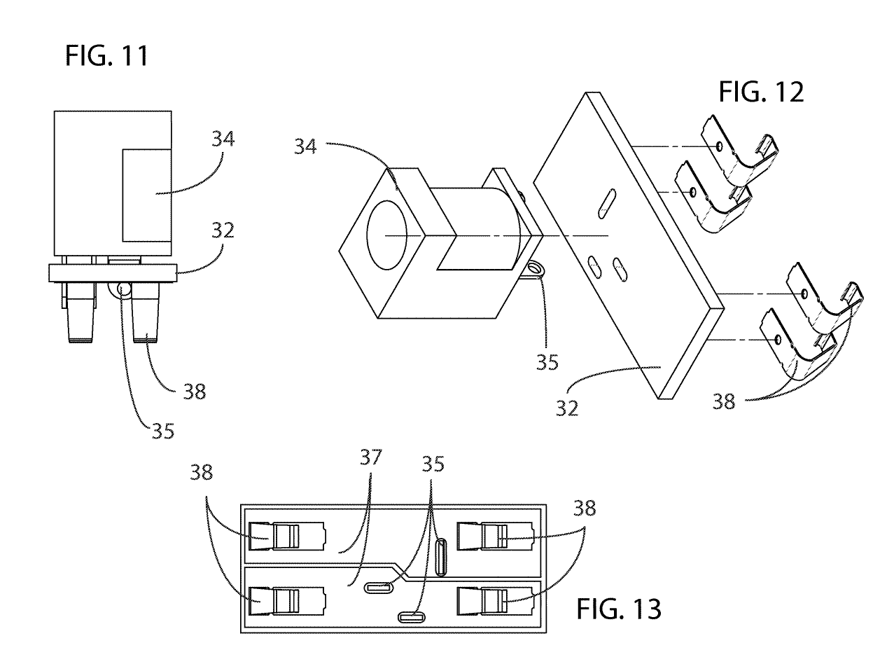

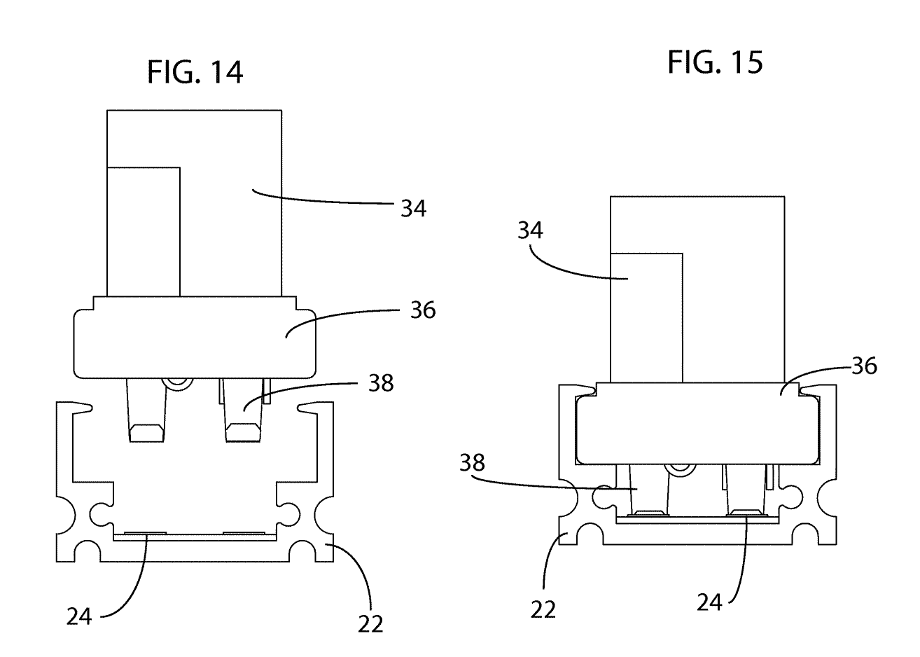

The PIC structure, shown in FIGS. 5-13, features a connection structure, such as barrel connector 34, coupled to a circuit board 32 at anchors 35. Different connection structures may be utilized, however barrel connectors are readily obtained and interface with a wide variety of A cover 36 fits over the circuit board 32 so as to provide an appropriate interface with the trench 26 (FIGS. 8, 14 & 15). Four prong connectors 38 extend from underneath the circuit board 32 in order to contact the leads 24. Standard circuit board tracing 37 forms a connective circuit between the barrel connector 34 (at anchors 35) and the prong connectors 38 (FIG. 13).

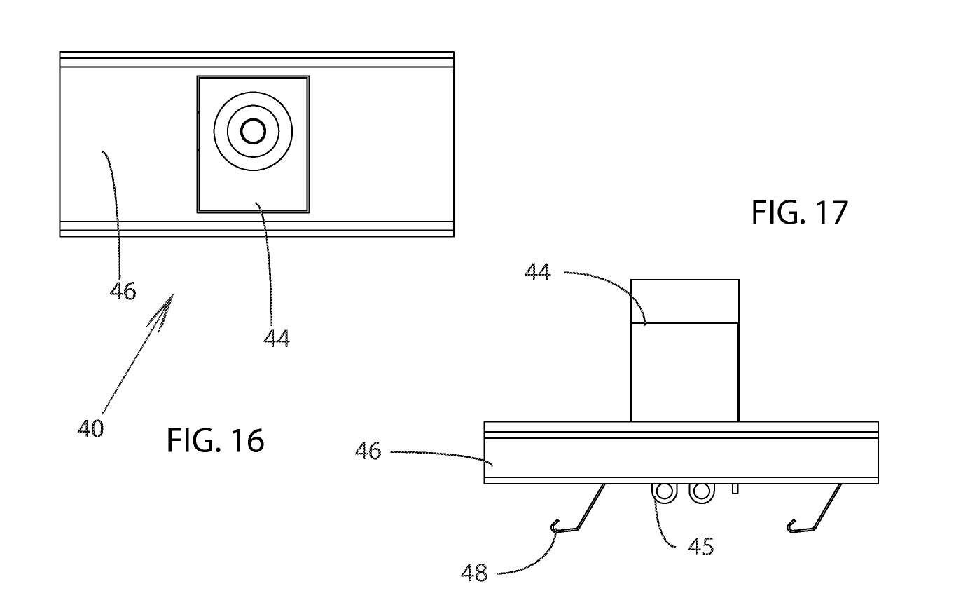

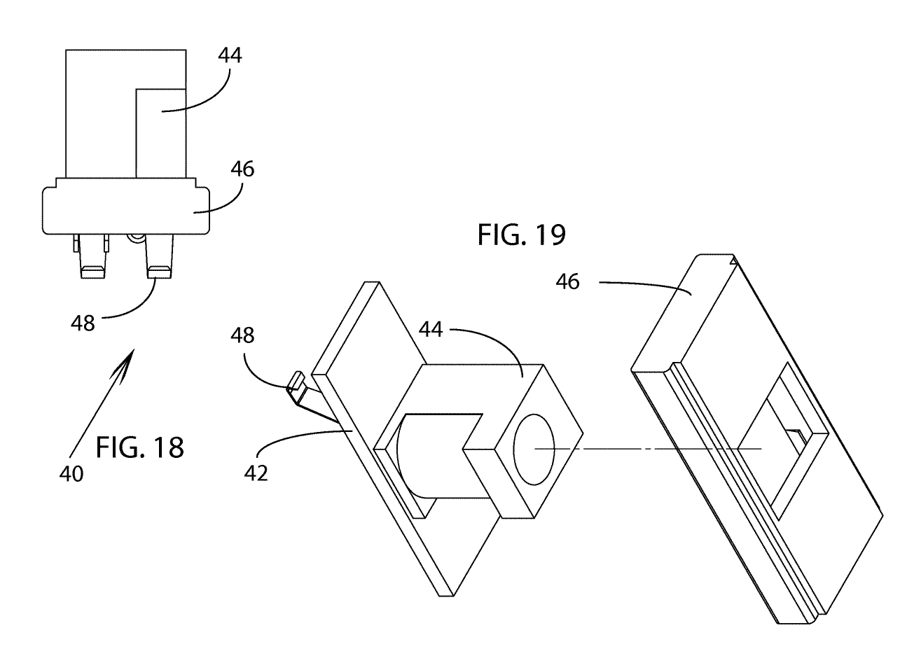

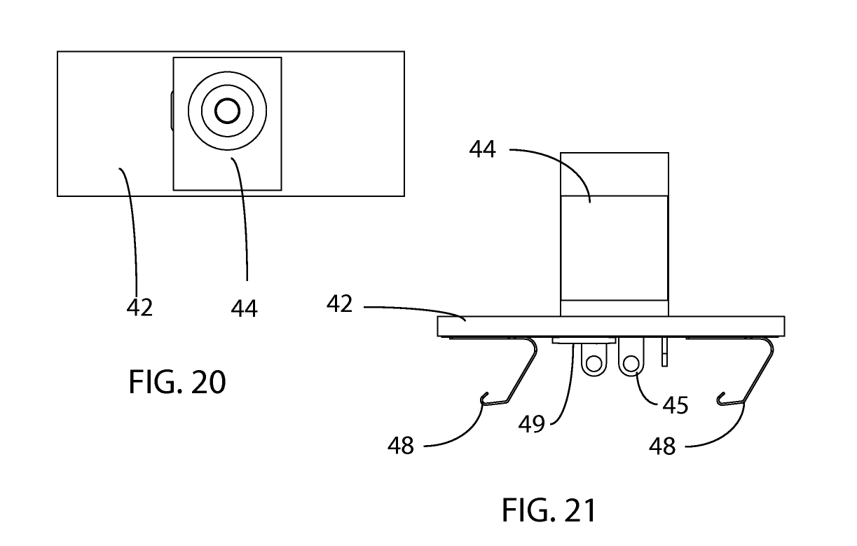

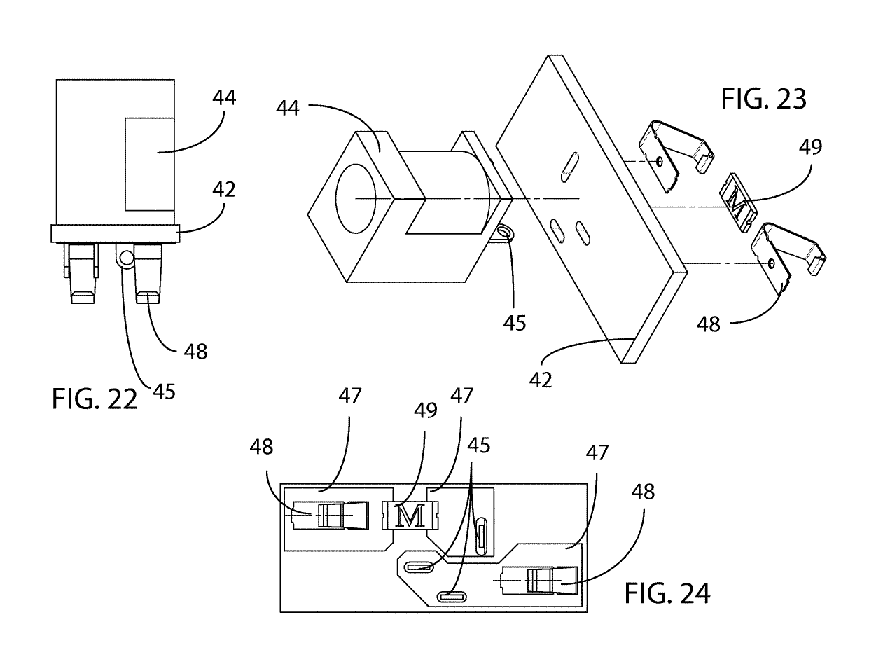

Construction of the POCs 40, as shown in FIGS. 16-24, is similar to the construction of the PICs. Like the PIC, a POC 40 is manufactured by attaching a barrel connector 44 to a circuit board 42 at anchors 45. They feature a similar cover 46 with which to interface with the trench 26. Unlike the PIC, only two prong connectors 48 are present, but are in operable connection with the barrel connector 44 due to standard circuit tracing 47 (FIG. 24) and, when installed in the power strip 10, the contact leads 24. An external surge suppression resistor 49 is provided as a bridge between two sections of circuit tracing 47. This provides inherent equipment protection for anything connected to the POCs 40. It is readily conceivable that other, additional surge suppression strategies and means may be utilized, including placing a similar resistor on a PIC.

In use, the power strip 20 is installed in some proximity to a merchandiser. This may be either as a retrofitting scenario or as a newly constructed fixture. An adequate number of POCs 40 are then slid into the power strip 20 and at least one PIC 30 is added and the end cap 28 positioned. Two such power strips 20 would be needed for most fixtures as most fixtures (either islands or gondolas) are used as one side of an aisle—requiring two sides of the fixture to be lighted independently of each other. A third strip may be utilized for a fixture end cap. Lighting is then installed to the fixture and attached to the POCs 30. LED lighting is preferred as it draws little power and creates minimal heat. It should also be realized that, especially when low power LEDs are used, that multiple power strips 20 may be daisy-chained together through the POCs 40 and PICs 30.

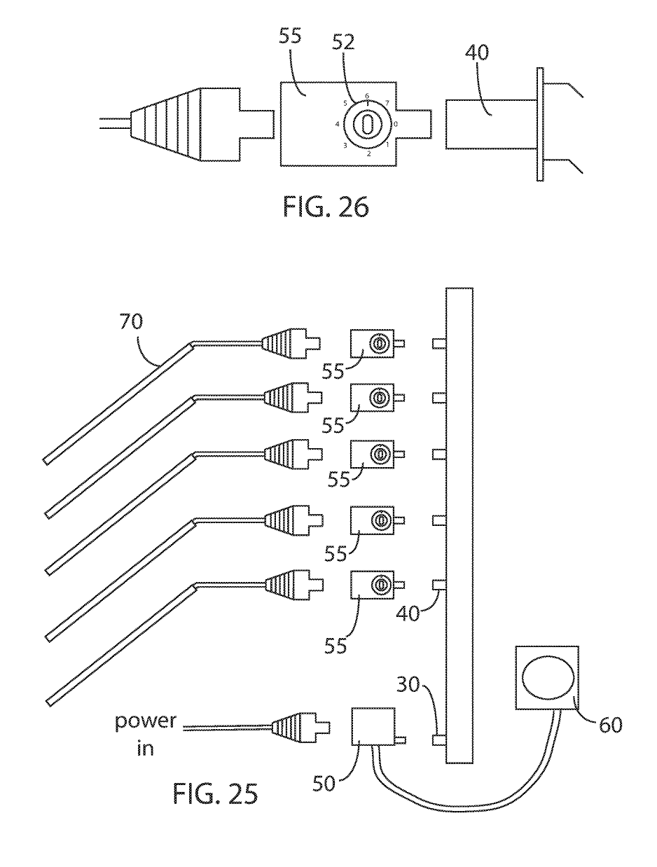

When each POC 40 and the PIC 30 is connected to the conductive leads 24 and an appropriate power supply connected to PIC 30 through the barrel connector 34 and suitable power loads connected to the POCs 40 through their barrel connectors 44, a plurality of parallel circuits are formed with power bleeding off through each POC 40 to energize individual loads 70 (FIG. 25). In its most preferred form, a lighting scheme may be generated by the introduction of timers 50, 55 and sensors 60 to the invention. A motion sensor 60 may be utilized to provide power to the PIC 30, and thereby power the system. This simple addition will cause a lighting scheme, or some other active display, to only activate when a customer is in proximity to the display. A timer 50 may be used in conjunction with the motion sensor 60 to cut power to the PIC 30 when no motion is detected for a given timeframe, such as 20 seconds, thereby saving energy and allowing the display to retain a “surprise” characteristic. Timers 55 may also be used to activate POCs 40 in some form of successive order, such as a cascading order. In so doing, the present invention may be made to generate more interactive and interesting lighting displays. As an example, for a cascading effect, these timers 55 may be used to delay powering adjacent POCs 30 in a range of 0.5 to 2 seconds (4 different lights, half a second apart from the previous light), though a range of 0.1 to 4 seconds or greater is feasible. A timer may also be integrated with the PIC or motion sensor to temporarily cut power to the system so that the process may be repeated. In so doing, a merchant may create even more interesting displays. Timers and sensors may be separate pieces as illustrated in FIG. 25, or may be integrated with the PICs 30 and POCs 40. Controls 52 for such components, shown in better detail in FIG. 26, may be any type known or later discovered in the art, including dials, DIP switches, and digital controls.

Although the present invention has been described with reference to preferred embodiments, numerous modifications and variations can be made and still the result will come within the scope of the invention. No limitation with respect to the specific embodiments disclosed herein is intended or should be inferred.

What is claimed is:

1. A power assembly comprising:
a. a power strip defining a trench with at least two conductive leads extending at least partially a length of the power strip within the trench;
b. at least one power-in-connector, the power-in-connector further comprising:
i. a connection structure for at least one power supply;
ii. a connector body shaped in conformity to fit within the trench;
iii. a printed circuit board residing within the connector body and operatively connected to the connection structure for at least one power supply; and
iv. at least one prong connector for each conductive lead, in operable connection with the printed circuit board and in operable connection with the at least one conductive leads when the power-in-connector is installed within the trench of the power strip;
c. at least one power-out-connector, the power-out-connector further comprising:
i. a connection structure for power loads;
ii. a connector body shaped in conformity to fit within the trench;
iii. a printed circuit board residing within the connector body and operatively connected to the connection structure for power loads; and
iv. at least one prong connector for each conductive lead, in operable connection with the printed circuit board and in operable connection with the at least one conductive leads when the power-out-connector is installed within the trench of the power strip; and
d. means for securing the at least one power-in-connector and at least one power-out-connector within the trench of the power strip;
wherein a power supply is connected to the at least one power-in-connector and at least one power utilizing load connected to the at least one power-out-connector, thereby forming a an electrical circuit.

2. The power assembly of claim 1, further comprising only one power-in-connector and a plurality of power-out-connectors, thereby forming a plurality of parallel electrical circuits.

3. The power assembly of claim 2, each power-in-connector further comprising four prong connectors and each power-out-connector further comprising two, the power strip further comprising two conductive leads.

4. The power assembly of claim 3, each power-out-connector further comprising a means for surge suppression.

5. The power assembly of claim 4, each power-out-connector further comprising a delay timer.

6. The power assembly of claim 4 further comprising a motion sensor operatively connected to the power-in-connector.

7. The power assembly of claim 3, each power-out-connector further comprising a delay timer.

8. The power assembly of claim 3 further comprising a motion sensor operatively connected to the power-in-connector.

9. The power assembly of claim 2, each power-out-connector further comprising a delay timer.

10. The power assembly of claim 2 further comprising a motion sensor operatively connected to the power-in-connector.

11. The power assembly of claim 1, each power-out-connector further comprising a delay timer.

12. The power assembly of claim 1 further comprising at least one motion sensor operatively connected to the at least one power-in-connector.

13. A method of providing an electrically powered display, the method comprising:
a. providing a power strip defining a trench with at least two conductive leads extending at least partially a length of the power strip within the trench;
b. providing at least one power-in-connector, the power-in-connector further comprising:
i. a connection structure for at least one power supply;
ii. a connector body shaped in conformity to fit within the trench;
iii. a printed circuit board residing within the connector body and operatively connected to the connection structure for at least one power supply;
iv. at least one prong connector for each conductive lead, in operable connection with the printed circuit board and in operable connection with the at least one conductive leads when the power-in-connector is installed within the trench of the power strip;
c. providing at least one power-out-connector, the power-out-connector further comprising:
i. a connection structure for power loads;
ii. a connector body shaped in conformity to fit within the trench;
iii. a printed circuit board residing within the connector body and operatively connected to the a connection structure for power loads;
iv. at least one prong connector for each conductive lead, in operable connection with the printed circuit board and in operable connection with the at least one conductive leads when the power-out-connector is installed within the trench of the power strip;
d. providing means for securing the at least one power-in-connector and at least one power-out-connector within the trench of the power strip;
e. providing at least one motion sensor in operable connection with the power-in-connector;
f. connecting at least one power load to the at least one power-out-connector; and
g. connecting at least one power supply to the at least one power-in-connector;
wherein the at least one motion sensor activates and provides power to the at least one power-in-connector when motion in a vicinity of the at least one motion sensor, thereby completing an electrical circuit.

14. The method of claim 13 the at least one power-out-connectors further comprising at least one timer.

15. The method of claim 14, wherein only one power-in-connector and a plurality of power out connectors are provided, thereby creating a plurality of parallel circuits when completed.

16. The method of claim 15, the at least one power loads being lights.

17. The method of claim 13, wherein only one power-in-connector and a plurality of power out connectors are provided, thereby creating a plurality of parallel circuits when completed.

18. The method of claim 17, the at least one power loads being lights.

19. The method of claim 13, the at least one power loads being lights.
